(19) United States
(12) Patent Application Publication
(10) Pub. No.: US 2008/0005926 A1
(43) Pub. Date: Jan. 10, 2008

(54) APPARATUS AND METHOD FOR REDUCING CLOTHES DRYER LINT ACCUMULATION IN EXHAUST VENTS

(76) Inventor: David M. Goggin, Loveland, CO (US)

Correspondence Address: COCHRAN FREUND & YOUNG LLC, 2026 CARIBOU DR, SUITE 201, FORT COLLINS, CO, 80525, US

(21) Appl. No.: 11/456,069

(22) Filed: Jul. 6, 2006

(51) Int. Cl. F26B 19/00; F26B 11/02

(52) U.S. Cl. 34/605; 34/85

(57) ABSTRACT

An apparatus and method for reducing lint accumulation from a clothes dryer exhaust in a dryer exhaust system, by increasing the airflow through the exhaust system over that generated by the dryer exhaust fan is described. A blower or fan is used to direct a flow of air into a flow coupler into which the dryer exhaust conduit is vented, such that the airflow reduces the pressure in the dryer exhaust conduit, thereby increasing the flow and reducing the accumulation of lint therein.

### FIELD OF THE INVENTION

The present invention relates generally to venting systems for clothes dryers and, more particularly to the reduction of lint accumulation in clothes dryer vents.

### BACKGROUND OF THE INVENTION

Clothes dryers must vent hot air from the dryer to the outside of the house. Lint becomes detached from the clothes and is carried out through the exhaust. The U.S. Consumer Product Safety Commission estimates that clothes dryers were associated with more than 15,500 fires, which resulted in numerous deaths and many more injuries, and caused more than $84 million in property damage. Such fires are more common than chimney fires.

Fires can occur when lint builds up in the dryer or in the exhaust duct, thereby slowing the air movement through the dryer and the exhaust system. The slower air movement causes more lint to be collected on the backside of the dryer drum, on the motor or on the electrical connections inside the dryer, and causes excessive heat build-up in the dryer motor. Highly combustible lint, when placed on or in the proximity of heat sources can readily ignite. Such fires may be fed by lint accumulated in the vents as well. A cleaned lint screen traps only 75% of the lint.

Poor dryer vent design leading to poor dryer venting is a leading cause of this problem. Most people prefer to keep their dryer pushed as close to the wall as possible, this leaves little room for the pipe to come out and turn. Vent pipes are often crushed in an effort to place the dryer closer to the wall, which creates a trap for lint to collect. Further, dryer venting tends to sag if it is not guided through the rafters with rigid ducting. The curves stop the lint from blowing out. Lint also becomes trapped in the ribs of the ducting, thereby creating pockets of potentially flammable debris. This creates an even more extreme problem when heavy winds are blowing.

Present solutions to this problem include the use of sheet metal vent pipes, the use of pop rivets instead of screws to connect metal vent pipe pieces, and the use of dryer vent boosters. Sheet metal pipes are more fire resistant than the customary 4″ diameter white-plastic or aluminum-foil exhaust ducts, cannot easily be crushed between the dryer and the wall, and help contain a fire if one starts. Pop rivets do not collect as much lint as the threaded screws inside of the vent pipe. Dryer vent boosters are readily available as in-line fans for increasing duct airflow. However, such units are directly exposed to the lint in the exhaust flow, require a positive pressure sensing switch to detect dryer operation, and are recommended to be used with a secondary lint trap. If a motor failure occurs, airflow is restricted within the exhaust vent. It is also required that the booster fan airflow must not exceed the dryer fan capacity in order to prevent dryer fan cavitation and/or exhausting excess heat required for the drying cycle and compromising drying times.

Compressed-air powered Venturi pumps having no moving parts and based on the Bernoulli principle that as fluid velocity increases as a result of a restriction in a fluid line, pressure decreases, are well known. Vacuum pumps based on this principle are useful for creating vacuums in the range between 50 and 500 Torr.

Accordingly, it is an object of the present invention to provide a method and apparatus for reducing lint accumulation inside of a dryer exhaust vent.

Another object of the invention is to provide a method and apparatus for reducing lint accumulation inside of a dryer exhaust vent without additional structure in line with the exhaust airflow.

Additional objects, advantages and novel features of the invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects, and in accordance with the purposes of the present invention, as embodied and broadly described herein, the apparatus for reducing accumulation of lint in a clothes dryer exhaust conduit from exhaust airflow from the dryer, hereof, includes: a fan or blower for generating an airflow; a flow coupler having a first input port, a second input port and an output port, the second input port, to which port the exhaust conduit is connected, being disposed between the first input port and the output port; a flow-area reducing member having a larger port and a smaller port, for receiving the airflow generated by the fan or blower in the larger port thereof, the smaller port being connected to the first input port of the flow coupler; and a flow-area increasing member having a larger port and a smaller port, the smaller port thereof being connected to the output port of the flow coupler such that the exhaust airflow and the airflow from the fan or blower exit the flow coupler through the output port thereof as a combined airflow, whereby the exhaust airflow from the clothes dryer is increased as a result of the airflow from the fan flowing through said flow coupler, and lint accumulation is reduced in the exhaust conduit.

In another aspect of the present invention, in accordance with its objects and purposes, the method for reducing accumulation of lint in a clothes dryer exhaust conduit from exhaust airflow from the dryer, hereof, includes the steps of: flowing a chosen airflow having a flow velocity into a first input port of a flow coupler having a first input port, a second input port and an output port, the exhaust conduit being connected to the second input port which is disposed between the first input port and the output port; and exhausting the exhaust airflow and the chosen airflow through a flow-area increasing member to a selected location, whereby the exhaust airflow from the clothes dryer is increased as a result of the chosen airflow flowing through the flow coupler and flow-area increasing member, and lint accumulation is reduced in the exhaust conduit.

In yet another aspect of the present invention, in accordance with its objects and purposes, the apparatus for reducing accumulation of lint in a clothes dryer exhaust conduit from exhaust airflow from the dryer, hereof, includes: a fan or blower for generating an airflow; a flow coupler having a first input port for receiving the airflow from the fan or blower, a second input port to which port the exhaust conduit is connected, and an output port, the second input port being disposed between the first input port and the output port; and a flow-area increasing member having a larger port and a smaller port, the smaller port thereof being connected to the output port of the flow coupler such that the exhaust airflow and the airflow from the fan or blower exit the flow coupler through the output port thereof as a combined airflow, whereby the exhaust airflow from the clothes dryer is increased as a result of the airflow from the fan flowing through the flow coupler, and lint accumulation is reduced in the exhaust conduit.

Benefits and advantages of the present invention include, but are not limited to, reducing lint accumulation in a clothes dryer exhaust system without requiring in-line fans or blowers and additional lint filters.

### BRIEF DESCRIPTION OF THE DRAWINGS

The accompanying drawings, which are incorporated in and form a part of the specification, illustrate two embodiments of the apparatus of the present invention and, together with the description, serve to explain the principles of the invention. In the drawings:

FIG. 1 is a schematic representation of a side view of a “T”-shaped flow coupler into which flowing air is introduced from a flow-velocity increasing member and exits through a flow-velocity decreasing member, and the exhaust conduit from the dryer is connected to a second input port of the flow coupler.

FIG. 2 is a schematic representation of a side view of a second embodiment of the dryer exhaust system of the present invention showing a “Y”-shaped flow coupler into which flowing air is introduced from a blower or fan through a conduit and exits through a flow-velocity decreasing member, and the exhaust conduit from the dryer is connected to a second input port of the flow coupler.

FIG. 3A is a schematic representation of the dryer exhaust system of the present invention, illustrating the use of the three-way “T”- or “Y”-shaped flow coupler described in FIG. 1 or FIG. 2 hereof disposed above the location of the dryer, wherein the pressure in the dryer exhaust conduit in the vicinity of the flow coupler is reduced, thereby increasing the flow therethrough such that air, water vapor and lint are directed out of the building, while FIG. 3B is a schematic representation of a side view thereof where the three-way, “T”- or “Y”-shaped flow coupler is located below the dryer.

### DETAILED DESCRIPTION OF THE INVENTION

Briefly, the present invention includes an apparatus and method for decreasing accumulation of lint entrained in the dryer exhaust airflow in the dryer exhaust vent by increasing the flow in the vent over that generated by the dryer exhaust fan, thereby reducing the accumulation of lint in the dryer exhaust system. A blower or fan directs air into a flow-area reducing member, wherein the area through which the flow passes is decreased and the velocity of the airflow increases, the exit or small port thereof being connected to one input of a three-way, “T”- or “Y”-shaped flow coupler, a second input of which is connected to a dryer exhaust conduit. An exit port of the coupler directs the combined flow from the blower and the dryer into a flow-area increasing member, wherein the area through which the flow passes is increased and the velocity of the airflow decreases. The flow-area increasing member is connected to a conduit which directs the combined flow to a chosen location, generally out of the structure in which the dryer is located. The airflow from the fan in the flow coupler causes the pressure in the dryer venting conduit to be reduced in the vicinity of the flow coupler by the Venturi effect, the airflow in the venting conduit being increased thereby.

In another embodiment of the invention, a blower or fan directs air directly into one input of a “T”- or “Y”-shaped, three-way flow coupler, a second input of which is connected to a dryer exhaust conduit. An exit port of the coupler directs the combined flow from the blower and the dryer into a flow-area increasing member, wherein the area through which the flow passes is increased and the velocity of the airflow decreases. The flow-area increasing unit is connected to a conduit which directs the combined flow to a chosen location, generally out of the structure in which the dryer is located. The airflow from the fan in the flow coupler causes the pressure in the dryer venting conduit to be reduced in the vicinity of the flow coupler, again by the Venturi effect, the airflow in the venting conduit being increased thereby, the flow coupler performing as a Venturi pump.

The flow coupler may be located above or below the dryer depending upon whether the exhaust system is disposed in the ceiling above, or in the floor below which the dryer is positioned. The fan or blower may advantageously also serve as a room exhaust fan.

Pipes and/or ducts may be used for the airflow conduits described herein. Although flanged fittings are shown in the FIGURES, the apparatus hereof may be integrally constructed, constructed using pipes and/or ducts which are designed to fit into one another, or constructed using a combination of these fittings.

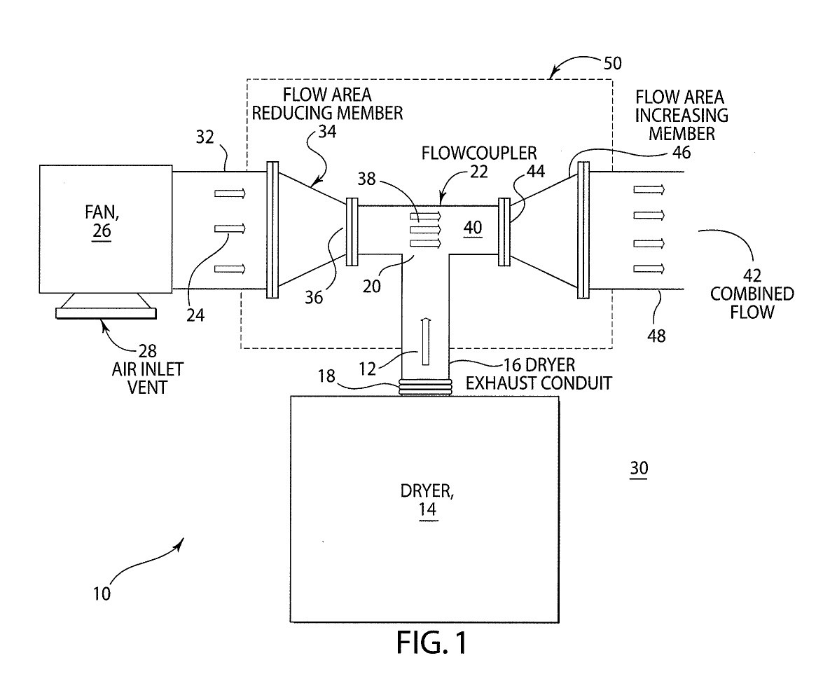

Reference will now be made in detail to the present embodiments of the present invention, examples of which are illustrated in the accompanying drawings. Similar or identical structure is identified using identical callouts. Turning now to the FIGURES, FIG. 1 is a schematic representation of a side view of dryer exhaust system, 10, of the present invention. Exhaust flow, 12, including air, water vapor and lint generated by a fan or blower (not shown in FIG. 1) within dryer, 14, is directed into dryer exhaust conduit, 16, through dryer vent coupling, 18, which may be a flexible coupling. Conduit 16 is connected to first port, 20, of three-way, “T”- or “Y”-shaped flow coupler, 22. Airflow, 24, generated by room exhaust fan or blower, 26, which exhausts air through air inlet vent, 28, from room, 30, in which dryer 14 is located, is directed into conduit, 32, which is connected to flow area reducing member, 34, in which the velocity of airflow 24 is increased. Reducing member 34 is connected to second port, 36, of three-way flow coupler 22, such that the flow rate, 38, of airflow 24 is increased and the pressure in volume, 40, of coupler 22 is reduced, thereby reducing the pressure in exhaust conduit 16. The reduction in pressure in pipe 16 causes an increase flow 12 therein, thereby reducing the accumulation of lint in pipe 16, with a consequent reduction in fire danger. Airflows 12 and 38 are combined in three-way pipe coupling 22, as combined flow, 42, which flows through exit port, 44, of three-way pipe coupler 22 into flow area increasing member 46. Member 46 directs airflow, 42, into conduit 48 which is vented to the outside of the building in which dryer 14 is located.

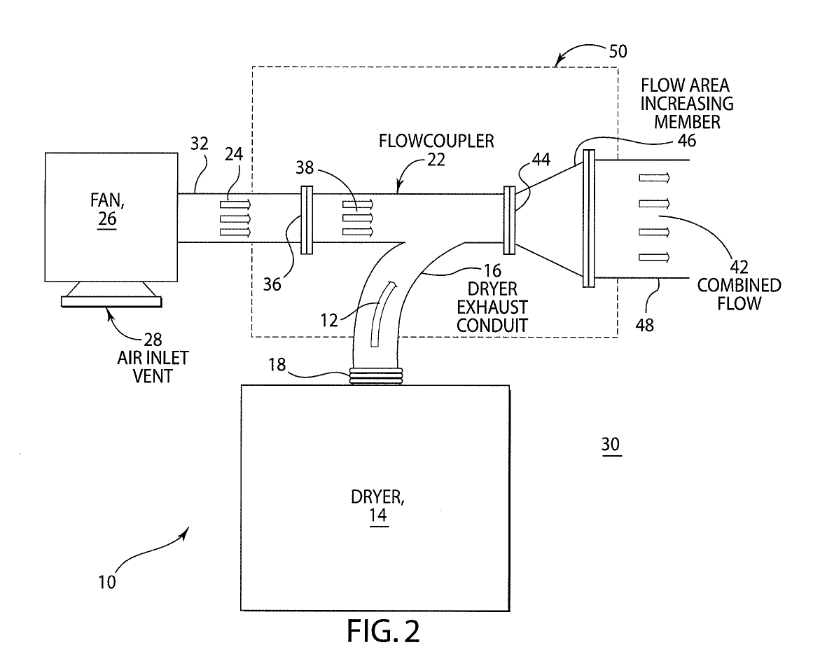

FIG. 2 is a schematic representation of a side view of a second embodiment of the dryer exhaust system 10 of the present invention showing “Y”-shaped flow coupler 22 into which flowing air 24 is introduced from blower or fan 26 through conduit 32 and exits coupler 22 through flow-velocity decreasing member 46, and exhaust conduit 16 from dryer 14 is connected to second input port 20 of flow coupler 22. Clearly, several shapes for flow coupler 22 may be used.

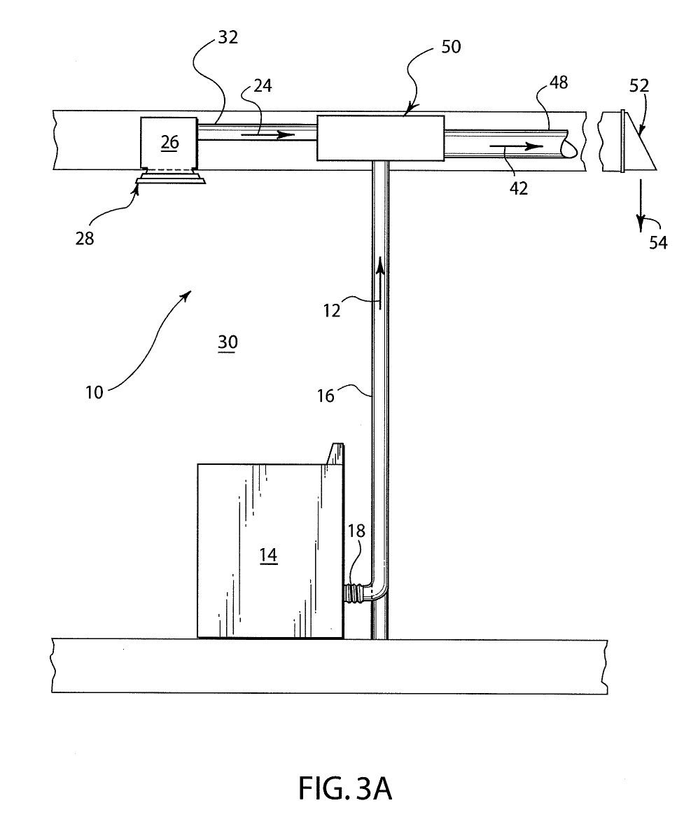

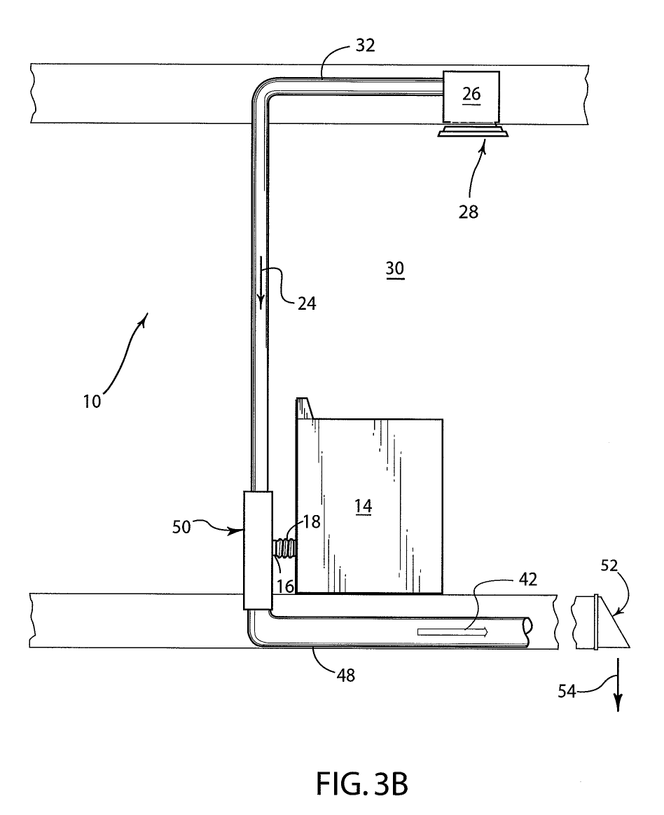

FIG. 3A is a schematic representation of the dryer exhaust system 10 of the present invention, illustrating the use of the three-way “T”- or “Y”-shaped flow coupler, 50, described in FIG. 1 or FIG. 2 hereof disposed above the location of the dryer, wherein the pressure in the dryer exhaust conduit in the vicinity of the flow coupler is reduced, thereby increasing the flow therethrough such that air, water vapor and lint are directed out of the building through vent, 52, as flow 54.

FIG. 3B is a schematic representation of a side view of dryer exhaust system, 10, of the present invention in which three-way flow coupler 22 with input and output fixtures 50 are disposed below the location of dryer 14.

In operation, fan 26 would be turned on through a direct electrical connection with dryer 14 when dryer 14 begins its drying process, and continue running until about 5 min. after dryer 14 has completed the process and has been turned off, as an example. Clearly, other periods may be chosen before stopping fan 26 after the drying cycle is completed. Moreover, since fan 26 exhausts air from room 27, it may be left running for extended periods. It is advantageous to use room air for creating the vacuum in vent pipe 16 in accordance with the teachings of the present invention, since during winter periods, air intake from either the attic or from outside of the building in which dryer 14 is located will cause water condensation in flow coupler 22 and pipe 48.

The vacuum formed in dryer vent pipe 16 with its attendant increased airflow may cool the dryer heating element more quickly after the drying cycle is complete, thereby prolonging dryer life. With the increased airflow in vent pipe 16, longer lengths of pipe or ducting may be employed. Further, since fan 26 is not located in the airflow containing water vapor and lint, no lint filter is needed other than that provided inside dryer 14.

It is anticipated that with exhaust vent conduit 16 having a 4″ diameter, conduit 32 having 3″ diameter, and exit conduit 48 of flow-area increasing member 46 having a 6″ diameter, fan 26 would need to provide an airflow of approximately 50 cfm or 1000 fpm.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An apparatus for reducing accumulation of lint in a clothes dryer exhaust conduit from exhaust airflow from the dryer, which comprises in combination:
a fan or blower for generating an airflow;
a flow coupler having a first input port, a second input port to which port said exhaust conduit is connected, and an output port, the second input port being disposed between the first input port and the output port of said flow coupler;
a flow-area reducing member having a larger port and a smaller port, for receiving the airflow generated by said fan or blower in the larger port thereof, the smaller port being connected to the first input port of said flow coupler; and
a flow-area increasing member having a larger port and a smaller port, the smaller port thereof being connected to the output port of said flow coupler such that the exhaust airflow and the airflow from said fan exit said flow coupler through the output port thereof as a combined airflow, whereby the exhaust airflow from said clothes dryer is increased as a result of the airflow from said fan or blower flowing through said flow coupler, and lint accumulation is reduced in said exhaust conduit.

2. The apparatus of claim 1, further comprising a first conduit connected to the larger port of said flow-area increasing member for receiving the combined airflow, and for directing the combined airflow to a selected location.

3. The apparatus of claim 1 further comprising a second conduit connected to the larger port of said flow-area reducing member for receiving the airflow from said fan or blower and for directing the airflow into said flow-area reducing member;

4. The apparatus of claim 1, wherein said exhaust conduit, said first conduit and said second conduit are selected from the group consisting of pipes and ducts.

5. The apparatus of claim 1, wherein said flow coupler is selected from the group consisting of “Y” couplers and “T” couplers.

6. The apparatus of claim 1, wherein said fan or blower comprises a room exhaust fan or blower.

7. The apparatus of claim 1, wherein said fan or blower is operated when said clothes dryer is operated, and for a chosen period after said clothes dryer is off.

8. A method for reducing accumulation of lint in a clothes dryer exhaust conduit from exhaust airflow from the dryer, which comprises the steps of:
flowing a chosen airflow having a flow velocity into a first input port of a flow coupler having a first input port, a second input port and an output port, the second input port being disposed between the first input port and the output port, and the exhaust conduit being connected to the second input port; and
exhausting the exhaust airflow and the chosen airflow through a flow-area increasing member to a selected location, whereby the exhaust airflow from the clothes dryer is increased as a result of the chosen airflow flowing through the flow coupler and flow-area increasing member, and lint accumulation is reduced in the exhaust conduit.

9. The method of claim 8, wherein the exhaust conduit, the flow coupler and the flow-area increasing unit are selected from the group consisting of pipes and ducts.

10. The method of claim 8, wherein the bidirectional coupler is selected from the group consisting of “Y” couplers and “T” couplers.

11. The method of claim 8, wherein said step of flowing a chosen airflow into the first input port of a flow coupler is accomplished using a room exhaust fan or blower.

12. The method of claim 11, further including the step of increasing the velocity of the chosen airflow.

13. The method of claim 12, wherein said step of increasing the velocity of the chosen airflow is accomplished using a flow-area reducing member having a larger port and a smaller port, the larger port thereof receiving the chosen airflow.

14. The method of claim 11, wherein the fan or blower is operated when the clothes dryer is operated, and for a chosen period after the clothes dryer is off.

15. An apparatus for reducing accumulation of lint in a clothes dryer exhaust conduit from exhaust airflow from the dryer, which comprises in combination:
a fan or blower for generating an airflow;
a flow coupler having a first input port for receiving the airflow from said fan or blower, a second input port to which port said exhaust conduit is connected, and an output port, the second input port being disposed between the first input port and the output port; and
a flow-area increasing member having a larger port and a smaller port, the smaller port thereof being connected to the output port of said flow coupler such that the exhaust airflow and the airflow from said fan or blower exit said flow coupler through the output port thereof as a combined airflow, whereby the exhaust airflow from said clothes dryer is increased as a result of the airflow from said fan flowing through said flow coupler, and lint accumulation is reduced in said exhaust conduit.

16. The apparatus of claim 15, further comprising a first conduit connected to the larger port of said flow-area increasing member for receiving the combined airflow, and for directing the combined airflow to a selected location.

17. The apparatus of claim 15, further comprising a second conduit connected to said flow coupler for receiving the airflow from said fan or blower and for directing the airflow into said flow coupler;

18. The apparatus of claim 15, wherein said exhaust conduit, said first conduit and said second conduit are selected from the group consisting of pipes and ducts.

19. The apparatus of claim 15, wherein said flow coupler is selected from the group consisting of “Y” couplers and “T” couplers.

20. The apparatus of claim 15, wherein said fan or blower comprises a room exhaust fan or blower.

21. The apparatus of claim 15, wherein said fan or blower is operated when said clothes dryer is operated, and for a chosen period after said clothes dryer is off.
